(19) United States
(12) Patent Application Publication
(10) Pub. No.: US 2022/0399608 A1
(43) Pub. Date: Dec. 15, 2022

(54) ENERGY STORAGE DEVICE ENCLOSURE SYSTEM

(71) Applicant: GLOBAL GRID ENERGY, Huntington Beach, CA (US)

(72) Inventor: Shujen YU, Huntington Beach, CA (US)

(73) Assignee: GLOBAL GRID ENERGY, Huntington Beach, CA (US)

(21) Appl. No.: 17/623,981

(22) PCT Filed: Jul. 3, 2019
(86) PCT No.: PCT/US2019/040605

§ 371 Date: Dec. 30, 2021

(51) Int. Cl. H01M 50/291; H01M 50/204; H01M 50/271; H01M 10/613; H01M 10/6563; H01M 50/244; H01M 8/2475; H01M 8/04014

(52) U.S. Cl. CPC H01M 50/291; H01M 50/204; H01M 50/271; H01M 10/613; H01M 10/6563; H01M 50/244; H01M 8/2475; H01M 8/04014; H01M 2220/10; H01M 2250/10

(57) ABSTRACT

In an example implementation, an energy storage device storage system is disclosed. The energy storage device storage system may include an energy storage device enclosure configured to be disposed between a first longitudinal support structure and a second longitudinal support structure. The first and second longitudinal support structures can extend between first and second support structures. The energy storage device enclosure may include one or more slots configured to receive an energy storage device. The one or more slots each include one or more ports configured to provide an electrical connection to the energy storage device. The energy storage device enclosure may further include one or more jammers attached to outer sidewalls of the energy storage device enclosure. The one or more jammers configured to hold the energy storage device enclosure between the first and second support structures.

### BACKGROUND

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure is directed to an energy storage device storage system and more particularly to an energy storage device storage system that can be installed within an industrial environment or a residential environment.

Homes and/or businesses may use renewable power to power the home and/or business. These homes and/or businesses may use an energy storage device to store excess power, and the excess power can be used to power the home and/or business at a later time or provide the excess power to the energy grid. However, these energy storage devices occupy space within the home and/or business.

### SUMMARY

Further areas of applicability of the present disclosure will become apparent from the detailed description, the claims and the drawings. The detailed description and specific examples are intended for purposes of illustration only and are not intended to limit the scope of the disclosure.

In an example implementation, an energy storage device storage system is disclosed. The energy storage device storage system may include an energy storage device enclosure configured to be disposed between a first longitudinal support structure and a second longitudinal support structure. The first and second longitudinal support structures can extend between first and second support structures. The energy storage device enclosure may include one or more slots configured to receive an energy storage device. The one or more slots each include one or more ports configured to provide an electrical connection to the energy storage device. The energy storage device enclosure may further include one or more jammers attached to outer sidewalls of the energy storage device enclosure. The one or more jammers configured to hold the energy storage device enclosure between the first and second support structures.

In other features, the energy storage device storage system includes an enclosure cover.

In other features, the energy storage device storage system includes at least one fan configured to introduce air into the energy storage device enclosure or at least one fan configured to remove air from the energy storage device enclosure.

In other features, the ports are configured to provide an electrical interconnection to the energy storage device.

In other features, the one or more jammers each include a claw end that is configured to interface with the first and second support structures.

In other features, the claw end defines one or more saw tooth edges.

In other features, the energy storage device storage system includes a biasing member configured to bias the one or more jammers with respect to the outer sidewalls of the energy storage device enclosure.

In other features, each slot includes a partition to guide and maintain the energy storage device in position.

An energy storage device storage system is disclosed. The energy storage device storage system may include an energy storage device enclosure configured to be disposed between first and second support structures. The energy storage device enclosure may include one or more slots configured to receive an energy storage device. The one or more slots include one or more ports configured to provide an electrical connection to the energy storage device. The energy storage device enclosure may further include one or more spacers that extend from outer sidewalls of the energy storage device enclosure. The energy storage device storage system may further include one or more jammers attached to the outer sidewalls of the energy storage device enclosure. The one or more jammers are configured to hold the energy storage device enclosure between the first and second support structures.

In other features, the energy storage device storage system includes an enclosure cover.

In other features, the one or more jammers comprise wood beam jammers.

In other features, the energy storage device storage system includes at least one fan configured to introduce air into the energy storage device enclosure or at least one fan configured to remove air from the energy storage device enclosure.

In other features, the one or more jammers each include a claw end that is configured to interface with the first and second support structures.

In other features, the claw end defines at least one saw tooth edge.

In other features, the energy storage device storage system includes a biasing member configured to bias the one or more jammers with respect to the outer sidewalls of the energy storage device enclosure.

In other features, the biasing member comprises a torsion spring disposed between at least one jammer and the outer sidewalls of the energy storage device enclosure.

An energy storage device storage system is disclosed. The energy storage device storage system may include an energy storage device enclosure configured to be disposed between first and second support structures. The energy storage device enclosure includes one or more slots configured to receive an energy storage device. The one or more slots include one or more ports configured to provide an electrical connection to the energy storage device. The energy storage device storage system also includes one or more jammers attached to outer sidewalls of the energy storage device enclosure. The one or more jammers are configured to hold the energy storage device enclosure between the first and second support structures. The energy storage device storage system also includes a biasing member configured to bias the one or more jammers with respect to the outer sidewalls of the energy storage device enclosure. Each jammer comprises a claw end configured to interface with the first and second support structures.

In other features, the biasing member comprises a torsion spring disposed between at least one jammer and the outer sidewalls of the energy storage device enclosure.

In other features, the energy storage device storage system includes a biasing retention mechanism that is configured to bias an enclosure cover with respect to the energy storage device enclosure.

An energy storage device storage system is disclosed. The energy storage device storage system may include an energy storage device enclosure configured to be disposed between a first adjustable longitudinal support structure and a second adjustable longitudinal support structure. The first and second adjustable longitudinal support structures are configured to extend between first and second support structures. The energy storage device enclosure includes one or more slots configured to receive an energy storage device. The one or more slots include one or more ports configured to provide electrical connection to the energy storage device. The energy storage device enclosure also includes hangers connected to the energy storage device enclosure and located on opposite ends of the energy storage device enclosure. The hangers are configured to suspend the energy storage device enclosure from the first adjustable longitudinal support structure and the second adjustable longitudinal support structure.

### DRAWINGS

The present disclosure will become more fully understood from the detailed description and the accompanying drawings, wherein:

FIG. 1 is an isometric view illustrating an example energy storage device enclosure system according to an implementation of the disclosure.

FIG. 2A is an isometric view illustrating internal features of the energy storage device enclosure system according to an implementation of the disclosure.

FIG. 2B is a front view illustrating the energy storage device enclosure system including a door according to an example implementation of the disclosure.

FIG. 3A illustrates a close-up view of an energy storage device installation resting hook according to an example implementation of the present disclosure.

FIG. 3B illustrates a close-up view of a spring-loaded energy storage device latch according to an example implementation of the present disclosure.

FIG. 3C illustrates a close-up view of a hinged door of the enclosure cover according to an example implementation of the present disclosure.

FIG. 4 is an isometric view illustrating another example energy storage device enclosure system according to an implementation of the disclosure.

FIG. 5 illustrates a cross-sectional view of section 5-5 of the energy storage device enclosure system of FIG. 4 according to an implementation of the disclosure.

FIG. 6A illustrates a perspective side view of the example energy storage device enclosure system shown in FIGS. 4 and 5 according to an implementation of the disclosure.

FIG. 6B illustrates a close-up view of a hook according to an example implementation of the present disclosure.

FIG. 6C illustrates a close-up view of an example catch latch arrangement according to an implementation of the disclosure.

FIG. 7 illustrates an example side view of a jammer pivotally connected to the energy storage device storage system that is biased away from an outer sidewall of an energy storage device enclosure by a biasing member according to an implementation of the present disclosure.

In the drawings, reference numbers may be reused to identify similar and/or identical elements.

### DETAILED DESCRIPTION

With the growth and expansion of renewable energy sources, commercial and residential buildings may need to be flexible in accommodating renewable energy solutions as well as energy storage solutions. In a pursuit for net zero energy buildings, flexible energy storage solutions may be useful in reducing dependency on the electrical grid. These buildings may need to accommodate energy storage devices, such as one or more batteries, fuel cells, or the like either in the building design phase or as a retrofit. Energy storage solutions that are flexible and safe and that can be easily incorporated in current construction standards without occupying valuable space may be key in efficient net zero energy buildings.

Certain implementations described herein may relate to an energy storage device enclosure system. For example, an example system may include an energy storage device enclosure configured to fit between a first longitudinal support structure and a second longitudinal support structure of a building. The first and second longitudinal support structures may extend between first and second support structures. The energy storage device enclosure may include one or more slots configured to receive energy storage devices where the one or more slots may each include one or more ports configured to provide electrical connection between an energy storage device and another device. The energy storage device enclosure may further include one or more partition members separating the one or more slots from each other. The system may further include hangers and/or jammers connected to the energy storage device enclosure and located on opposite ends of the energy storage device enclosure. The hangers and/or jammers may be configured to suspend the energy storage device enclosure from the first longitudinal support structure and the second longitudinal support structure.

The present disclosure may provide lower cost of installation as well as speed of installation of the energy storage device enclosure, minimizing impact on existing building structures as well as minimizing real-estate usage inside or outside the structure providing a quick fit approach to installation, and/or minimizing labor requirement during installation. For instance, the systems and method of energy storage device enclosure disclosed herein may be installed by one or more operators. The energy storage device enclosure can be installed within industrial environments (e.g., parking garages) or residential environments (e.g., residential garages, single family homes, condominiums, townhouses, etc.).

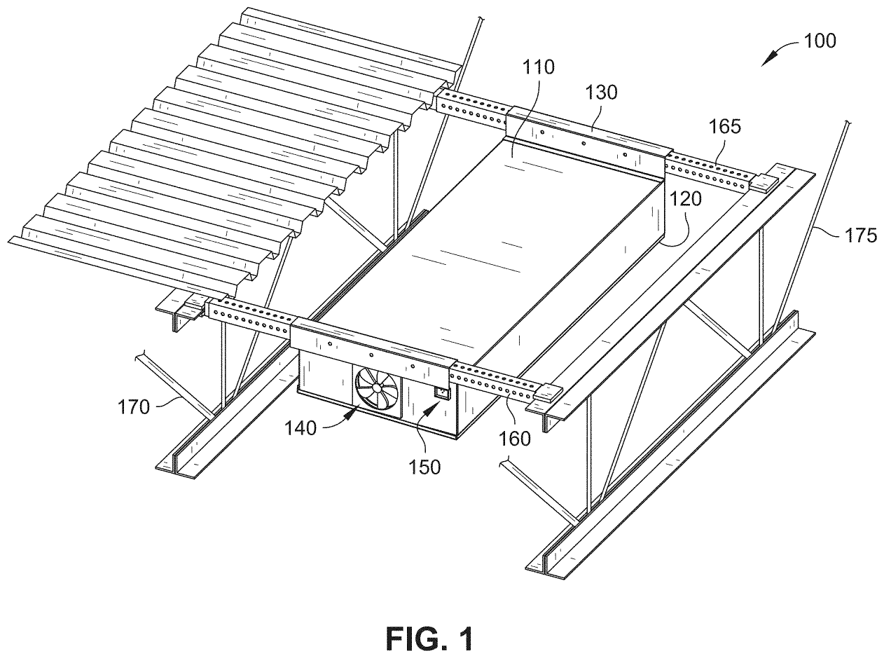

FIG. 1 illustrates an example energy storage device storage system 100. The energy storage device storage system 100 includes an energy storage device enclosure 110 that fits in between a first longitudinal support structure 160 and a second longitudinal support structure 165 of a building. It is understood that the building may be a residential structure or an industrial structure. The first longitudinal support structure 160 and the second longitudinal support structure 165 can extend between a first and a second support structure, such as ceiling support structures. As shown in FIG. 1, the energy storage device enclosure 110 may located in a bay between first and second support structures (e.g., trusses 170 and 175). In other implementations of the disclosure, the energy storage device enclosure 110 can be located in other suitable locations. The trusses 170 and 175 may be of a variety of materials, such as, for example, metal trusses, wooden trusses, and so on.

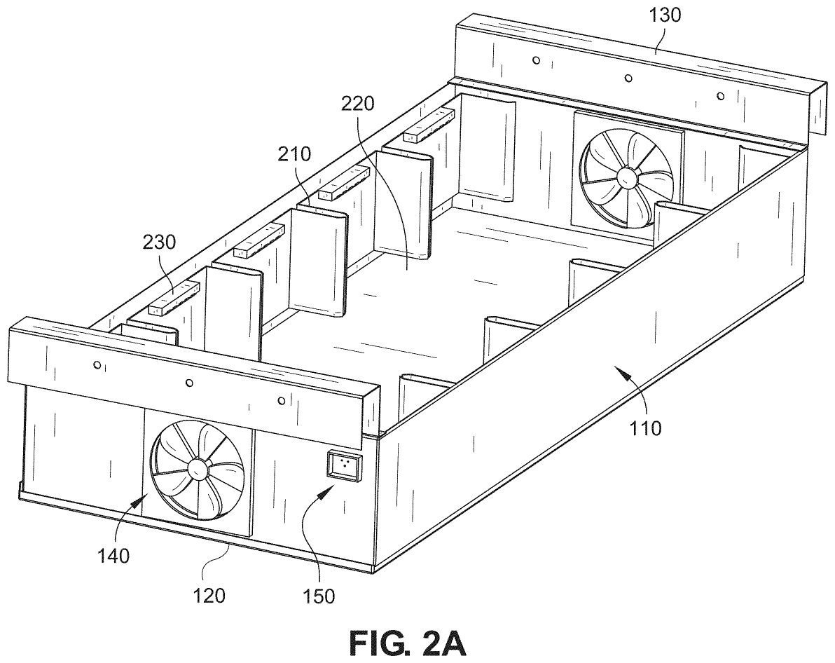

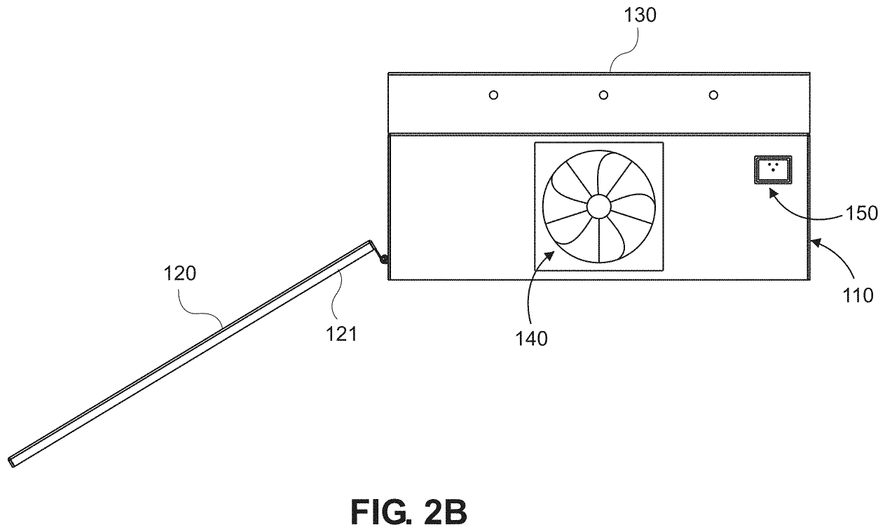

As shown in FIG. 2A, the energy storage device enclosure 110 may include a plurality of slots or bays that can receive one or more energy storage devices. For example, the energy storage devices may include, but are not limited to, lead acid batteries, lithium ion batteries, saltwater batteries, rechargeable batteries, sodium-ion batteries, molten-state batteries, fuel cells, and so on.

The energy storage device enclosure 110 can be manufactured from a variety of materials, such as, for example, stainless steel, aluminum, plastic, a composite material, and so on. The energy storage device enclosure 110 may also be installed in different types of buildings, including those made of wood, concrete, metal, and so on.

As shown in FIG. 1, hangers 130 can be attached to the energy storage device enclosure 110 and located on opposite ends of the energy storage device enclosure 110. The hangers 130 may be configured to suspend the energy storage device enclosure 110 from the first longitudinal structure 160 and the second longitudinal structure 165. Also, based on the distance between the trusses 170, the first longitudinal support structure 160 and the second longitudinal support structure 165 may be of adjustable lengths. The energy storage device enclosure 110 may be placed in the center of the first longitudinal support structure 160 or the second longitudinal support structure 165 or it may be offset in one direction, depending on the requirements of the building into which the energy storage device enclosure 110 may be installed. The design of hangers 130, the first longitudinal support structure 160, and the second longitudinal support structure 165 may be based on a detailed structural analysis that may have to take into account the energy storage device capacity to be stored in the energy storage device enclosure, weights, and sizes of the energy storage devices and the energy storage device enclosure, and so on.

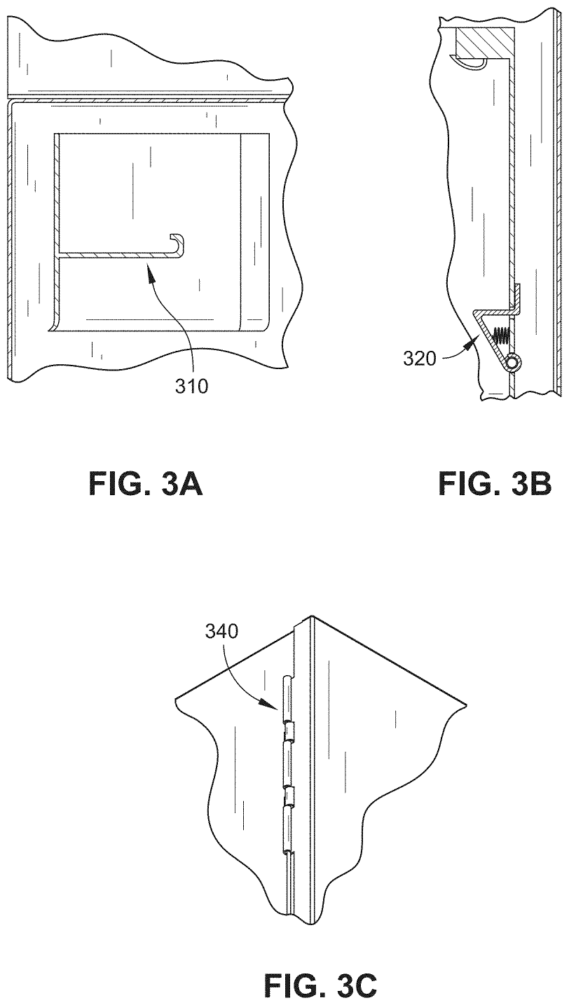

As shown in FIGS. 2A and 2B, the energy storage device storage system 100 may further include an enclosure cover 120. In some implementations, the enclosure cover 120 may include a door 121 that includes a latch and/or a lock. The door 121 may be pivotally connected to the energy storage device enclosure 110 via a hinge (see FIG. 3B). A user can access the energy storage device enclosure 110 via the door 121 during installation and/or maintenance. The enclosure cover 120 may also prevent dust, pests, and other foreign objects from entering the energy storage device enclosure 110. In some implementations, the enclosure cover 120 can include a soft open and close lid type arrangement for designs where the enclosure cover 120 may be downward-opening. The enclosure cover 120 can be located at the bottom of the energy storage device enclosure 110 for ease of operation and ease of access to the energy storage devices.

As shown in FIG. 1, the energy storage device storage system 100 can include at least one fan 140 that includes a dust filter that introduces or removes air into or from the energy storage device enclosure 110. In some implementations, the energy storage device storage system 100 can include multiple fans. For example, a first fan 140 can be used to introduce air into the energy storage device enclosure 110 and a second fan 140 can be used to remove air from the energy storage device enclosure 110. Keeping the energy storage device enclosure 110 cool may be an important consideration for the power holding capacity as well as longevity of the energy storage devices stored in the energy storage device enclosure 110. The fan 140 may include a variety of configurations, such as, for example, axial fans, centrifugal fans, a blower, an induced draft (ID) fan, an exhaust fan, a backward curved fan, and so on. The fan 140 can be driven by a motor that is powered from the energy storage devices stored in the energy storage device enclosure 110 or from the electrical grid. The fan 140 can include a variable frequency drive (VFD) to minimize energy usage. The energy storage device storage system 100 includes one or more connectors 150 that are configured to connect multiple enclosures and/or energy storage devices together to increase capacity.

FIG. 2A illustrates an internal configuration of the energy storage device enclosure 110 according to an example implementation. As shown, the energy storage device enclosure 110 includes one or more slots 220 that receive energy storage devices. For instance, the slots 220 may be sized to accommodate energy storage devices of a particular size and shape. The one or more slots 220 may also include one or more ports 230 to provide electrical connection between the energy storage devices and/or a secondary or external device (not shown). Even though FIG. 2A illustrates the ports 230 being located towards the top of the enclosure within each slot 220, the ports 230 may be located at the bottom or towards the side of each slot 220. The secondary device may include a different energy storage device enclosure 110, an external energy storage device, a renewable energy source, a residential electrical grid, or a commercial electrical grid.

The energy storage device storage system 100 also includes one or more partition members 210 that can separate the one or more slots 220 from each other. Each of the partition members can be shaped to accommodate one or more energy storage devices that may be stored in the energy storage device enclosure 110. The partition members 210 may be made of a variety of materials, such as, for example, metal, plastic, or a composite. Each slot 220 can include a latch or a catch that secures the energy storage devices after being received within the energy storage device enclosure 110. The energy storage device enclosure 110 can also encompass a modular design such that the slots 220 can be of varying size.

FIGS. 3A through 3C illustrates various internal portions of the energy storage device storage system 100. FIG. 3A illustrates an example hook 310 that is configured to retain the energy storage device in place. FIG. 3B illustrates an example catch latch mechanism 320 that secures energy storage devices to the energy storage device enclosure 110. FIG. 3C illustrates a hinge 340 of the enclosure cover 120. The hinge 340 may be of various types, such as, for example, spring loaded, barrel type, pivot type, and so on.

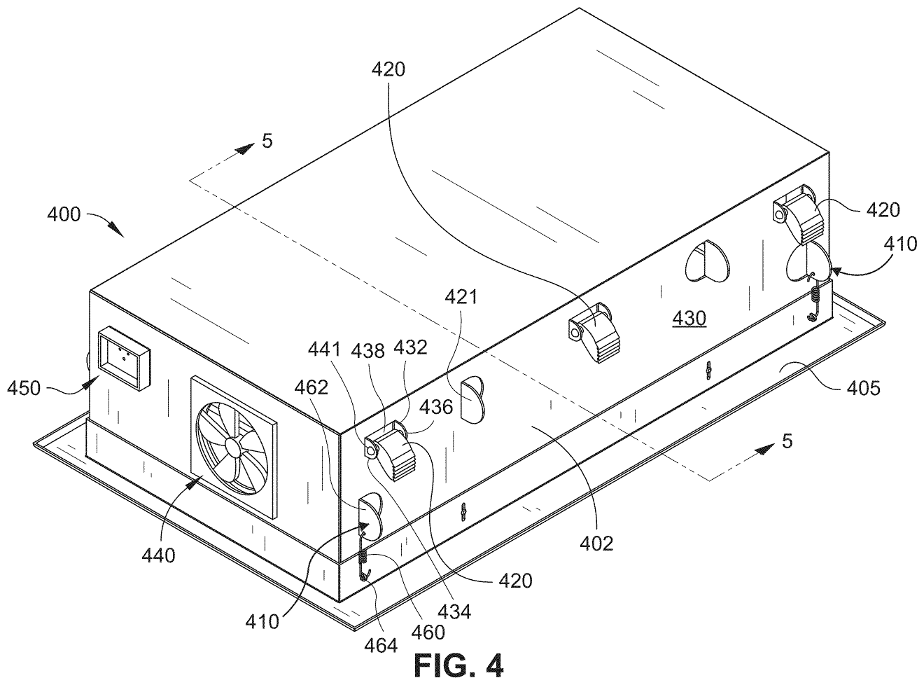

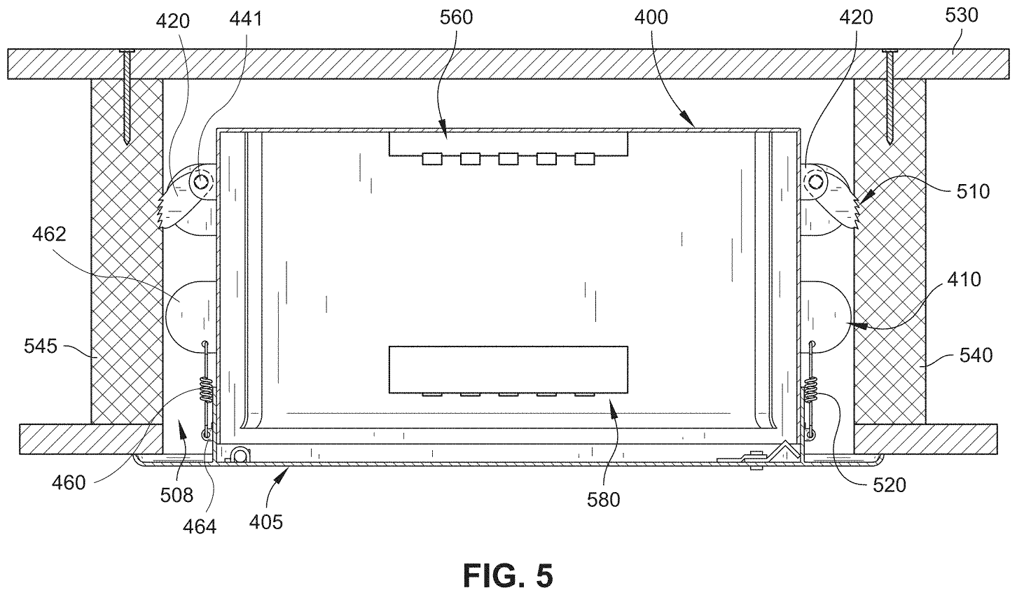

FIG. 4 illustrates another example implementation of an energy storage device storage system 400 that includes an energy storage device enclosure 402. The energy storage device enclosure 402 is configured to fit in between a first support structure (shown in FIG. 5) and a second support structure (shown in FIG. 5). According to example implementations of the disclosure, the energy storage device enclosure 402 may be located in a recess in a ceiling, between roof trusses, a space between joists, a ceiling of a garage, in an attic, between flooring support structures, and so on. The building structure may be of a variety of materials, such as, for example, wooden structures, and so on.

The energy storage device enclosure 402 may be made of a variety of materials, such as, for example, stainless steel, aluminum, plastic, or a composite material. The energy storage device enclosure 402 may also be installed in different types of buildings, including those made of wood construction, concrete construction, metal construction, and so on.

The energy storage device enclosure 402 can also include one or more jammers 420 that are attached to outer sidewalls 430 of the energy storage device enclosure 402. The one or more jammers 420 are configured to hold the energy storage device enclosure 402 between the first support structure (shown in FIG. 5) and the second longitudinal support structure (shown in FIG. 5). The jammers 420, for example, may be wood beam type jammers. In an example implementation, the jammers 420 can be pivotally connected to the sidewall 430 via a bracket 432. For example, the bracket 432 can include a first flange 434, a second flange 436, and a base portion 438. The jammers 420 can be connected to a rod 441 that extends between the flanges 434, 436, and the jammers 420 can pivot about the rod 441 during installation. The jammers 420 are described in greater detail with reference to FIG. 5.

The energy storage device storage system 400 may also include an enclosure cover 405. The enclosure cover 405 may be removable during installation and/or maintenance. The enclosure cover 405 includes a biasing retention mechanism 410 that is capable of holding the enclosure cover 405 in place when the enclosure cover 405 is closed. The biasing retention mechanism 410 may comprise a spring 460 having one end connected to a flange 462 and the other end connected to a collar 464. The flange 462 is connected to the sidewall 430 and may define an opening to receive one end of the spring 460. The collar 464 is connected to the enclosure cover 405 and is configured to receive the other end of the spring 460.

As shown, the energy storage device storage system 400 can include spacers 470. The spacers 470 may be configured to transition between an open position and a closed position. In an implementation, the spacers 470 may formed by applying one or more suitable punching techniques to the sidewall 430. In another implementation, the spacers 470 may be connected to the sidewalls 430 via one or more hinges, or the like. The spacers 470 may be in the open position when an axis defined as parallel to an outer surface of the spacers 470 is perpendicular to an axis defined as parallel to the sidewall 430. The spacers 470 may be in the closed position when the axis defined as parallel to the outer surface of the spacers 470 is parallel to an axis defined as parallel to the sidewall 430. The spacers 470 can be used to maintain the energy storage device storage system 400 centered with respect to the support structures, which are described in greater detail below.

The energy storage device storage system 400 also includes at least one cooling or ventilation fan 440 that introduces or removes air into or from the energy storage device enclosure 402. In certain implementations of the disclosure, additional fans may be provided. In these implementations, a first fan 440 can be used to introduce air into the energy storage device enclosure 402 and a second fan can be used to remove air from the energy storage device enclosure 402. The fan 440 may include a variety of configurations, such as, for example, axial fans, centrifugal fans, a blower, an induced draft (ID) fan, an exhaust fan, a backward curved fan, and so on. The fan 440 may receive power from the energy storage devices stored in the energy storage device enclosure 402 or from the electrical grid. The fan 440 may also include a variable frequency drive (VFD) to minimize energy usage. The energy storage device storage system 400 also includes one or more connectors 450 that are configured to connect multiple enclosures and/or energy storage devices together to increase capacity.

FIG. 5 illustrates a cross-sectional view 5-5 of the energy storage device enclosure 402 shown in FIG. 4. As shown, the energy storage device enclosure 402 is held between the first support structure 540 and the second support structure 545 by one or more jammers 420. The support structures 540, 545 are configured to support structural member 530. The structural member 530 may be part of a flooring of a second level or it may be part of a ceiling or roof of a garage or another building. The jammers 420 hold the energy storage device enclosure 402 between the first support structure 540 and the second support structure 545 via a respective claw end 510. The claw end 510 interfaces (e.g., grabs) the support structures 540, 545 as the energy storage device enclosure 402 is installed.

FIG. 5 illustrates an example structure where the energy storage device enclosure 402 may be installed. For example, the structure may include a residential structure such as a garage or an industrial structure. While described within the context of a garage installation, it is understood that the energy storage device enclosure can be installed within an industrial environment.

Once an opening 508 for the energy storage device enclosure 402 is created, the energy storage device enclosure 402 is lifted into the opening 508 with the claw ends 510 of the jammers 420. Once the energy storage device enclosure 402 has been lifted or pushed up, the claw ends 510 of the jammers 420 are biased such that the jammers 420 interface the support structures 540 and 545 via saw tooth edges so that the claw ends 510 interface with the first longitudinal support structure 540 and the second longitudinal support structure 545 by the spring force of the spring loaded claw end 510 attached to the energy storage device enclosure 402 creating a secure fit for the energy storage device enclosure 402 inside the opening 508. In this example, the first support structure 540 and the second support structure 545 may be wooden members and the claw ends 510 of the jammers 420 may be metal members. In other implementations of the disclosure, a variety of wood, or composite materials may be used for the support structures 540, 545 and the jammers 420.

The enclosure cover 405 can be held closed by a spring loaded mechanism 410. The spring loaded mechanism 410, including the spring 520, provides a securing mechanism for the enclosure cover 405. The enclosure cover 405 also extends beyond the opening 508 so that the energy storage device enclosure 402 remain obscured from an observer's view once the energy storage device enclosure has been installed. FIG. 5 also illustrates energy storage device circuit connection or ports 560 as well as a device 580 for securing the energy storage device inside the energy storage device enclosure 402.

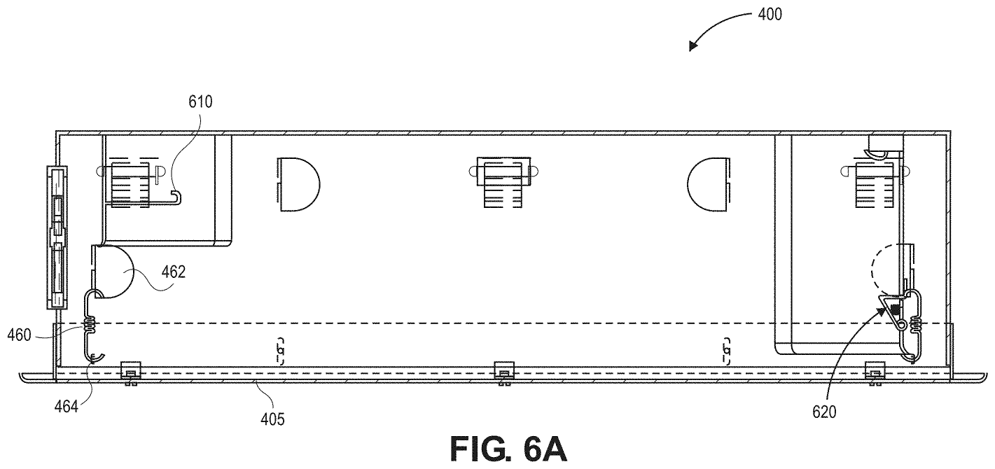

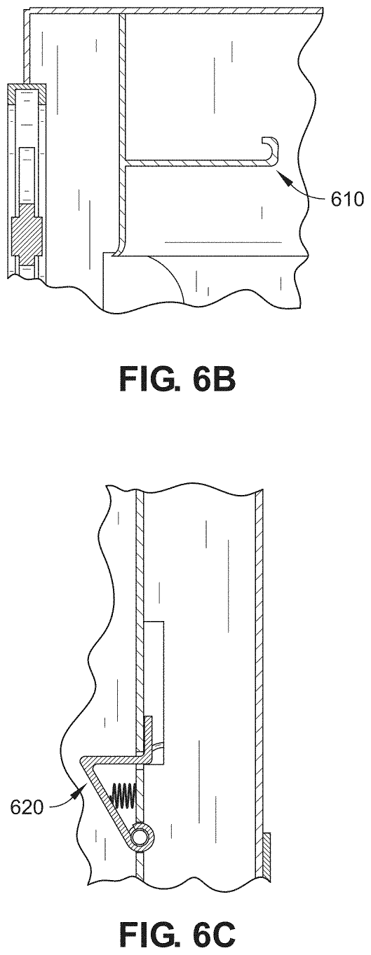

FIGS. 6A through 6C illustrate example implementations of the energy storage device storage system 400. FIG. 6A illustrates a side view of the energy storage device storage system 400. As shown in FIGS. 6A and 6B, the energy storage device storage system 400 includes a hook 610 that is configured to receive an energy storage device, an energy storage device case, or the like. The energy storage device storage system 400 can also include a catch latch mechanism 620 (see FIGS. 6A and 6C) FIG. 6B that may be used to secure energy storage devices to the energy storage device enclosure 402.

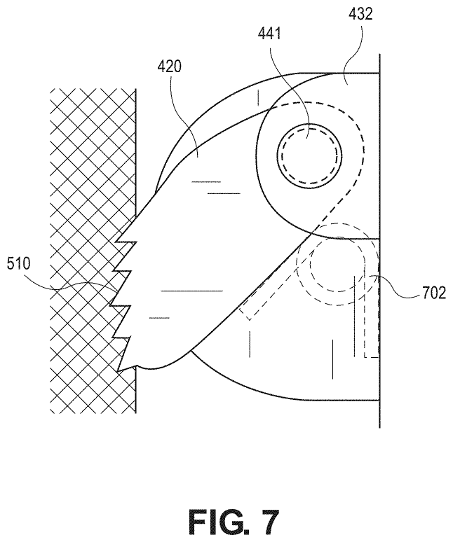

FIG. 7 illustrates a side view of a jammer 420 that is connected to the sidewall 430 of the energy storage device enclosure 402 via the bracket 432. In an example implementation, a biasing member 702 bias the jammer 420 with respect to the sidewall 430. The biasing member 702 can bias the jammer 420 in a first direction so that the claw end 510 maintains an interface with the support structures 540, 545. Additionally, an installer can exert a force on the jammer 420 in a second direction during installation such that jammer 420 can partially pivot with respect to the energy storage device enclosure 402. In an example implementation, the biasing member 702 may be a torsion spring. However, it is understood that other biasing members can be used.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A energy storage device storage system, comprising:
an energy storage device enclosure configured to be disposed between a first longitudinal support structure and a second longitudinal support structure, the first and second longitudinal support structures configured to extend between first and second support structures, the energy storage device enclosure comprising:
one or more slots configured to receive an energy storage device, the one or more slots each comprising one or more ports configured to provide an electrical connection to the energy storage device; and
one or more jammers attached to outer sidewalls of the energy storage device enclosure, the one or more jammers configured to hold the energy storage device enclosure between the first and second support structures.

2. The energy storage device storage system of claim 1, further comprising an enclosure cover.

3. The energy storage device storage system of claim 1, further comprising at least one fan configured to introduce air into the energy storage device enclosure or at least one fan configured to remove air from the energy storage device enclosure.

4. The energy storage device storage system of claim 1, wherein the ports are configured to provide an electrical interconnection to the energy storage device.

5. The energy storage device storage system of claim 1, wherein the one or more jammers each include a claw end that is configured to interface with the first and second support structures.

6. The energy storage device storage system of claim 5, wherein the claw end defines one or more saw tooth edges.

7. The energy storage device storage system of claim 1, further comprising a biasing member configured to bias the one or more jammers with respect to the outer sidewalls of the energy storage device enclosure.

8. The energy storage device storage system of claim 1, wherein each slot includes a partition to guide and maintain the energy storage device in position.

9. A energy storage device storage system, comprising:
an energy storage device enclosure configured to be disposed between first and second support structures, the energy storage device enclosure comprising:
one or more slots configured to receive an energy storage device, the one or more slots comprising one or more ports configured to provide an electrical connection to the energy storage device;
one or more spacers extending from outer sidewalls of the energy storage device enclosure; and
one or more jammers attached to the outer sidewalls of the energy storage device enclosure, the one or more jammers configured to hold the energy storage device enclosure between the first and second support structures.

10. The energy storage device storage system of claim 9, further comprising an enclosure cover.

11. The energy storage device storage system of claim 9, wherein the one or more jammers comprise wood beam jammers.

12. The energy storage device storage system of claim 9, further comprising: at least one fan configured to introduce air into the energy storage device enclosure or at least one fan configured to remove air from the energy storage device enclosure.

13. The energy storage device storage system of claim 9, wherein the one or more jammers each include a claw end that is configured to interface with the first and second support structures.

14. The energy storage device storage system of claim 13, wherein the claw end defines at least one saw tooth edge.

15. The energy storage device storage system of claim 9, further comprising a biasing member configured to bias the one or more jammers with respect to the outer sidewalls of the energy storage device enclosure.

16. The energy storage device storage system of claim 15, wherein the biasing member comprises a torsion spring disposed between at least one jammer and the outer sidewalls of the energy storage device enclosure.

17. A energy storage device storage system, comprising:
an energy storage device enclosure configured to be disposed between first and second support structures, the energy storage device enclosure comprising:
one or more slots configured to receive an energy storage device, the one or more slots comprising one or more ports configured to provide an electrical connection to the energy storage device;
one or more jammers attached to outer sidewalls of the energy storage device enclosure, the one or more jammers configured to hold the energy storage device enclosure between the first and second support structures; and
a biasing member configured to bias the one or more jammers with respect to the outer sidewalls of the energy storage device enclosure;
wherein each jammer comprises a claw end configured to interface with the first and second support structures.

18. The energy storage device storage system of claim 17, wherein the biasing member comprises a torsion spring disposed between at least one jammer and the outer sidewalls of the energy storage device enclosure.

19. The energy storage device storage system of claim 17, further comprising a biasing retention mechanism that is configured to bias an enclosure cover with respect to the energy storage device enclosure.

20. A energy storage system, comprising:
an energy storage device enclosure configured to be disposed between a first adjustable longitudinal support structure and a second adjustable longitudinal support structure, the first and second adjustable longitudinal support structures configured to extend between first and second support structures, the energy storage device enclosure comprising:
one or more slots configured to receive an energy storage device, the one or more slots each comprising one or more ports configured to provide electrical connection to the energy storage device; and
hangers connected to the energy storage device enclosure and located on opposite ends of the energy storage device enclosure, the hangers configured to suspend the energy storage device enclosure from the first adjustable longitudinal support structure and the second adjustable longitudinal support structure.
